(19) United States
(12) Patent Application Publication
(10) Pub. No.: US 2019/0304291 A1
(43) Pub. Date: Oct. 3, 2019

(54) DETACHABLE MOBILE SECURITY DEVICE

(71) Applicant: Diane Camp, Rosedale, CA (US)

(72) Inventor: Diane Camp, Rosedale, CA (US)

(21) Appl. No.: 16/117,068

(22) Filed: Aug. 30, 2018

Related U.S. Application Data
(60) Provisional application No. 62/650,778, filed on Mar. 30, 2018.

(51) Int. Cl. G08B 25/01; G08B 25/10; F16M 13/04; F16M 13/06

(52) U.S. Cl. CPC G08B 25/016; F16M 13/06; F16M 13/04; G08B 25/10

(57) ABSTRACT

A security device comprises a socket with an extendible and collapsible accordion-like compartment. The socket can attach substantially flat to a mobile device when the compartment is collapsed, and can be gripped when the compartment is extended. The socket can detach from the mobile device while the socket is gripped and the mobile device is pulled from the gripped socket by a second party. A radio transmitter in the compartment can be activated and deactivated. GPS circuitry in the socket enables transmission of location information. When activated, the transmitter transmits an RF alarm signal to a dispatch service with the location of the socket. In some embodiments the security device can be attached to an article, activated by a user of the security device if the article is stolen, and remain attached to the article, thus transmitting the location of the stolen item.

### RELATED APPLICATIONS

This application claims the benefit of priority of U.S. Provisional Application Ser. No. 62/650,778, filed on Mar. 30, 2018, which is incorporated herein by reference in its entirety.

### TECHNICAL FIELD

The subject matter disclosed herein relates general to a device which can be used to assist the user in ensuring his or her personal safety and to provide a method by which the user could easily be located in the event of emergency.

### BRIEF DESCRIPTION OF THE DRAWINGS

FIG. 1 is a photograph of a popsocket attached to a mobile phone, with the popsocket in extended mode.

FIG. 2 is a photograph of an extended popsocket.

FIG. 3A illustrates a popsocket-like security unit held by the user while a second party attempts to wrongfully take away from the user a mobile phone to which the popsocket is attached, according to some embodiments.

FIG. 3B illustrates the situation of FIG. 3A where the second party has taken the mobile phone from the user and the user retains the popsocket-like security unit, according to some embodiments.

FIG. 4 is a block diagram of an alarm system that can be activated by a user, according to some embodiments.

FIG. 5 is a side cutaway view of a popsocket with the alarm circuit included, according to some embodiments.

FIG. 6 illustrates an example of a wireless network according to some embodiments.

FIG. 7 illustrates an example machine according to some embodiments.

### DETAILED DESCRIPTION

Mobile phone, smart phone or other mobile device usage has become extremely common, and the detachable security device described herein is, in part, being proposed as an adjunct to such phones and other mobile devices, regardless of manufacturer. Devices commonly referred to as “pop ups” or “POPSOCKETS™” are popularly being used as accessories attached to the back of a mobile phone to enable users to have a grip or handle on the back of the phone. The device was designed to enhance a user's ability to take “selfies” and group photos, to prop the phone up to watch videos, to text or web surf, to make holding the phone easier during use, and for similar purposes. Current devices are made from rubber or aluminum, have an extendable accordion-like body, and adhere to the phone via an adhesive and/or suction cup which makes it quickly removable and replaceable.

One such device is currently produced by PopSockets LLC and is the subject of both US patent and trademark protections. (U.S. Pat. No. 8,560,031, D777,022; CN Patent No. 201530102271.3; EU Patent No. 002675843-0001 and JP Patent No. 6091438, 1537291) These devices are currently marketed at the following website: https://www.popsockets.com/. The devices are approximately 1 inch in diameter. An example of their appearance when fully extended for use is described below, and functions like a handle for the mobile phone or other device or article to which it is attached. When not extended, the handle lies flat against the phone.

Using a substantially similar design, Applicant proposes to create a security device which contains an undetectable silent electronic alarm which could be activated by the mobile phone user in case of an emergency. Depressing the center (or other area) of the security device would depress a switch that activates radio-like circuitry in the security device, discussed below, to send an alarm notice to a dispatching service provider much like those which are now used by medical alarm companies. Further, activation would initiate a tracking signal so that the user could be located at the time of activation and, in the event the user is abducted, it would continue to transmit from the security device as it travels with the user. It is envisioned that the device could be quickly detached from the mobile phone so that if the user were required to give up the mobile phone (or other item, sometimes referred to as “article,” onto which the device has been attached), it could be detached by the user quickly and nearly furtively, and remain with the owner or user. Current popsockets, and popsocket-like devices (“popsocket-like devices” hereinafter referred to as “security unit”) are contemplated as the detachable units, which are attached to a mobile device such as a smart phone, in some embodiments by a suction cup-type fastener, or other fastener, to provide the easily and furtively detachable function. A Velcro attachment might be more appropriate than the adhesive used by some embodiments of current pop ups to maximize the ability to detach it from the phone. It is proposed that the device be small enough to be secreted by the user, in a pocket or other hidden location, if detached, simply by furtively and quickly detaching the device when surrendering the mobile phone (when being forced to give it up). This could also be accomplished, in some embodiments, by the user holding the security unit, still attached to the mobile phone in extended mode, and handing the phone to the person demanding the phone, and allowing the phone to detach from the security unit while the user still holds the security unit. The common, approximately one-inch size of popsocket currently used by others, would be appropriate for furtive detachment, according to some embodiments. Further, a design that is consistent with what is currently available as a pop-up grip would help to disguise the true purpose of this product as a security transmitter. In some embodiments the device may be waterproof. In some embodiments, there would be a method to quickly notify the security dispatch service if the device is activated in error.

It is anticipated that the unit would contain a small, powerful battery which is not dependent on the mobile phone's battery. However, in some embodiments the unit could draw power from the mobile phone's battery. The security unit owner or user would provide the dispatching service with a name and number for a contact person, and the dispatching service could co-ordinate with that person as well as the appropriate law enforcement agency.

An alternative use could be to attach the device to the dash of a vehicle, a school notebook or school desk (keeping in mind recent school safety issues), back packs or lunch carriers and the like, or to place in a purse or briefcase; in short, to be used with anything which is easily portable and regularly used by the owner.

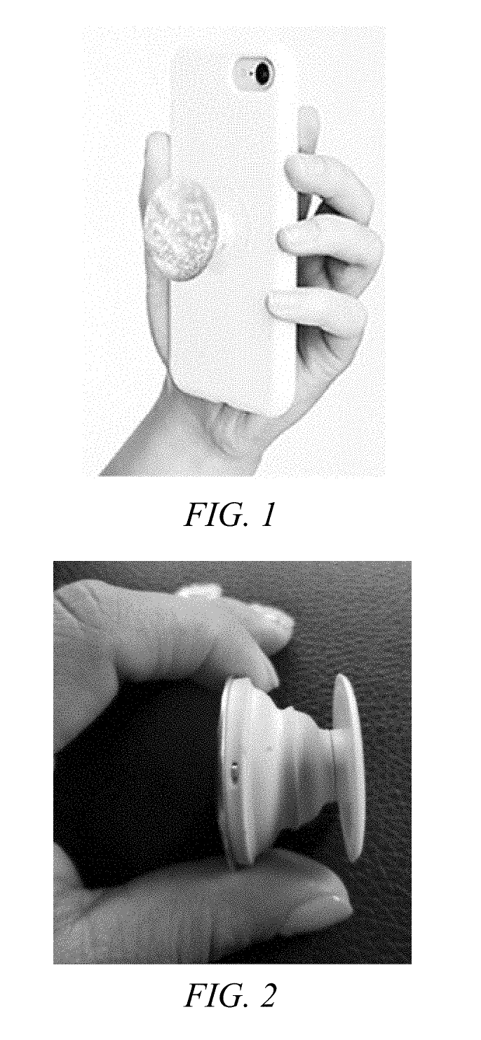

FIG. 1 is a photograph of a popsocket attached to a mobile phone, with the popsocket accordion-like body in extended mode. In FIG. 1 a user is holding a smart phone with a popsocket extended in such a way that if the popsocket is held by the user, and a second party tries to pull the phone away from the user, the popsocket, being attached by suction cup or similar attachment, will immediately detach.

FIG. 2 is a photograph of a popsocket in extended mode. The photograph shows a user holding the popsocket as an illustration of the extended mode of the popsocket. When used as described herein as a security unit attached to a mobile phone or other device, the security unit may be held securely by the user such that it will detach quickly from the device to which it is attached. In some embodiments, the detachment may be surreptitious when the device to which it is attached is taken from the user, as described in some examples below.

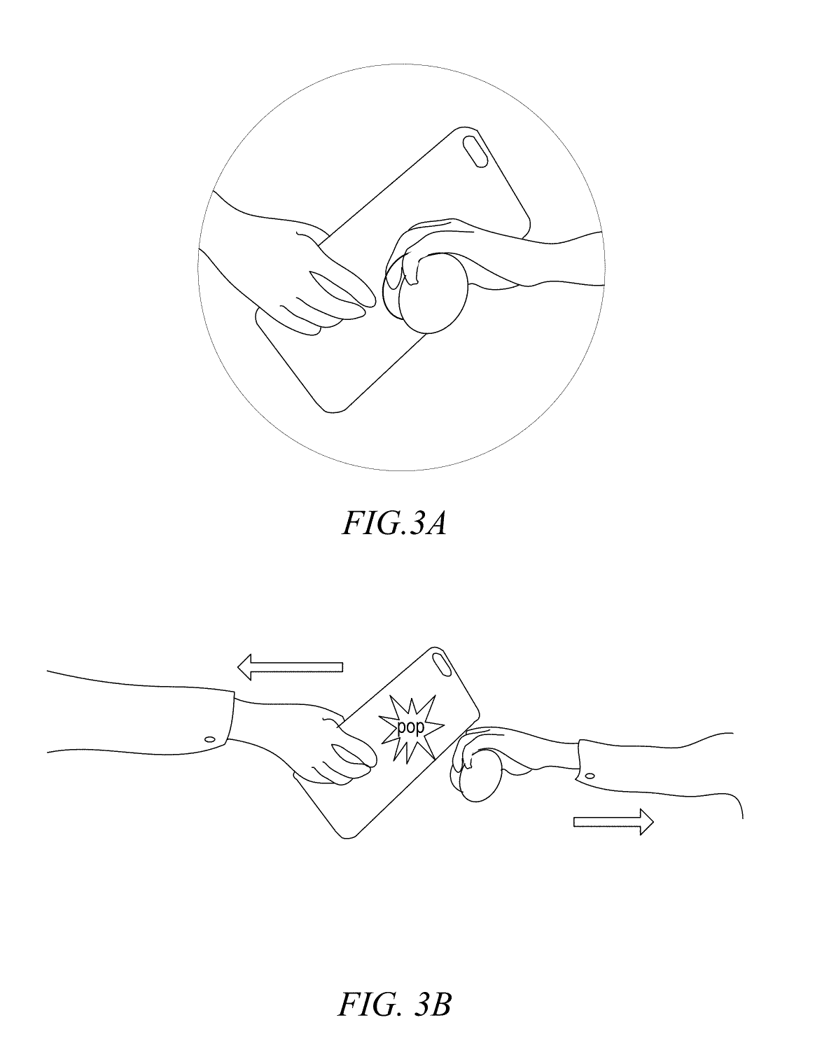

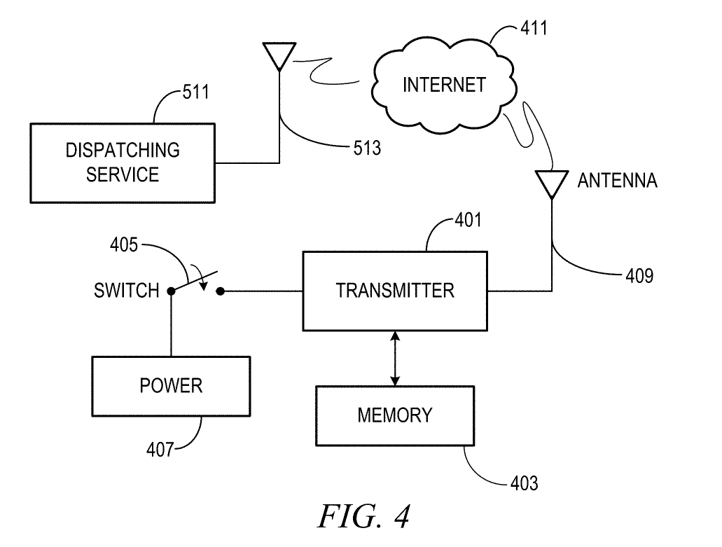

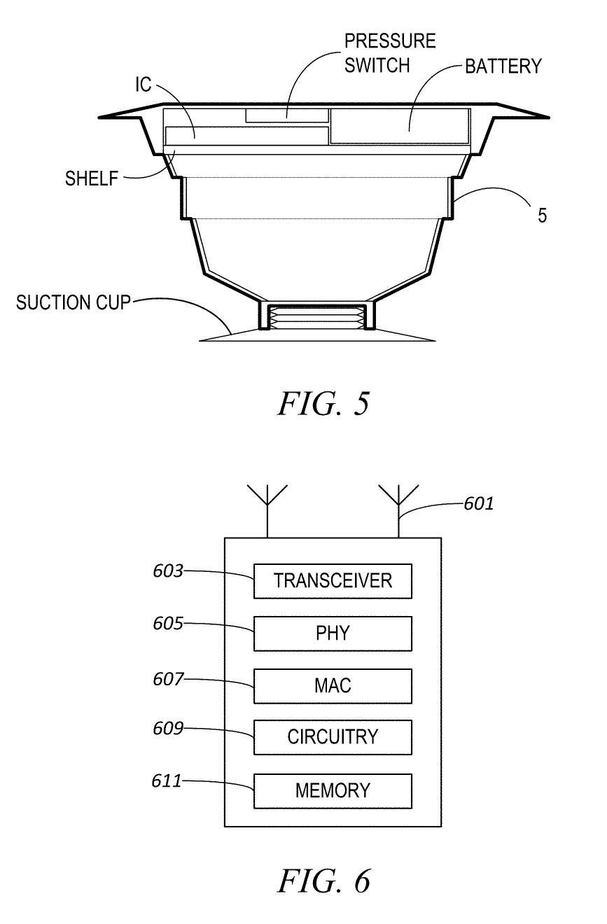

FIGS. 3A and 3B illustrate a process of using the disclosed subject matter, according to some embodiments. FIG. 3A illustrates a popsocket-like security unit held by the user while a second party attempts to wrongfully take away from the user a mobile phone or other mobile device to which the popsocket is attached, according to some embodiments. Normally the security unit would be attached to the phone in a substantially flat configuration (flat but for the depth of the IC, the battery and the switch discussed in FIG. 5). In FIG. 3A the security unit is illustrated attached to a mobile phone in extended mode, somewhat like a handle. In practice, if the user were in an emergency situation where a second party demands the phone, the user of the phone would quickly and surreptitiously extend the security unit to the extended mode seen in FIG. 3A and hold the security unit itself in a clasping grip, as if clasping the handle formed by the extended accordion-like part of the security unit. FIG. 3B illustrates the situation of FIG. 3A where the second party has taken the mobile phone from the user and the user retains the popsocket-like security unit, according to some embodiments, and the security unit remains gripped by the user. In FIG. 3B the second party, who has taken the phone, is holding the phone while the user is holding the pop socket-like device. In practice, the second party would usually be grasping the phone to take it away from the user, while the user would be grasping or gripping the security unit as if it were a handle, or clenching the handle between fingers of one hand, as surreptitiously as possible. The user may have already depressed, or otherwise activated, the switch upon sensing that he or she is in an emergency situation where the second party is demanding the phone, or is trying forcefully to take the phone from the user. The result is that the second party will have the phone, but the user will have the security unit which is transmitting the alarm to the security dispatch company, and also tracking the location of the user. Another example is that the user may decide that the location of the mobile device or other article should be tracked, instead of the location of the user being tracked if a second party takes the mobile device. In this example, when the user senses that he or she is in an emergency situation, like having the phone stolen by a second party, the user may depress or otherwise activate the switch while the security device is attached to the mobile device or other article in the substantially-flat configuration, and simply hand or surrender the phone or other article to the second party who is demanding the phone, and the now activated security device is transmitting the location of the phone or other article to the dispatch service, as discussed below with respect to FIGS. 4 and 5. If the article under discussion is a vehicle, the security unit could be attached to the dash board of the vehicle for use in transmitting the location of the vehicle if the vehicle is taken or stolen. In any embodiment, including this example, the second party may not notice that the security unit has been activated.

While the foregoing has been described for a situation where a mobile phone is being taken form the user, the disclosed subject matter is not limited to being used with a mobile phone. There are several alternative uses. As discussed above, alternative uses could be to attach the device to a school notebook or school desk, back packs or lunch carriers and the like, or to place in or on a purse or briefcase; in short, to be used with anything which is easily portable, regularly used by the owner, or user, and subject to being snatched or taken.

FIG. 4 is a block diagram of an alarm system 400 for the mobile security device, which can be activated by a user, according to some embodiments. System 400 may be embodied within the security unit. In some embodiments system 400 comprises transmitter 401 that may be coupled to switch 405 that, in turn, may be coupled to power source 405 which may be an appropriate battery. The transmitter may be configured to transmit information to a dispatching service, as discussed below. The security unity may include, either within the transmitter or separately, tracking circuitry, which may comprise GPS tracking circuitry, so that when activated the security unit can be tracked. Transmitter 401 may be coupled to memory 403. Computer memory may also be included within transmitter 401. Transmitter 401 may be coupled to antenna 403. When switch 405 is placed in the closed position by the user depressing the security unit switch, the transmitter in some embodiments may be coupled to power source 407 to automatically begin transmitting an alarm. The system may be embodied in a popsocket-like device to convert that device into a security unit. Independent dispatching service 511 is configured in some embodiments to receive the transmitted alarm from the transmitter in the security unit via antenna 513. Memory 403, or a memory within transmitter 401, may store computer programs and or data used to configure the system. The memory may be implemented using RAM and/or ROM memory. In some embodiments, one or more programs may configure the transmitter to send a message, with the user's identity, to a dispatching service to notify the dispatching service that the user is in an emergency situation and that appropriate authorities should be summoned. The memory may also store identifying information for user of the detachable security device. For example, the memory may store a serial number or other identifier for the detachable security device, which identifies the user. The memory may also store, for example, information identifying the user of the detachable security device (e.g., by name and/or other identifier). The identifier may be modulated onto a carrier by transmitter 401 and sent via antenna 409. Concurrently, the tracking circuitry of the security unit may be activated so the unit may be tracked. In some embodiments the modulated signal may be received by an evolved Node B (eNB) device for transmission to the dispatching service 511. Transmission may be via the Internet 411.

FIG. 5 is a side cutaway view of a popsocket-like security device with the alarm circuit included, according to some embodiments. Popsocket-like devices are seen in greater detail in U.S. Pat. No. 8,560,031, which is incorporated herein by reference in its entirety. The popsocket of the foregoing patent is one example of a device that can become the security device or security unit disclosed herein, although the disclosed device is not limited to a popsocket. Other devices that have the characteristics of being detachably affixed to a mobile device or to a cover for a mobile device can be used as well. As seen in FIG. 5, an integrated circuit (IC) that comprises transmitter 401 of FIG. 4, as well as other well-known transmitter and tracking circuitry is situated on an appropriate supporting member which, in some embodiments, may be shelf situated within accordion-like structure 5 such as that described in the forgoing patent. A battery is included to be coupled to the IC via the illustrated pressure, or other suitable type activation, switch, with operation being as discussed with respect to FIG. 4, according to some embodiments.

FIG. 6 illustrates an example a mobile station (MS) device in accordance with some embodiments. The mobile station may be the unit inside the security unit, according to some embodiments. MS device 600 is a more detailed description of one or more of the wireless devices 110a-110c of FIG. 1A. MS device 600 may be a mmWave-compliant MS device that may be arranged to communicate with one or more other MS devices or one or more BS. As discussed above, MS device 600 may be suitable for operating as UE. In some embodiments, MS device 600 may include, among other things, a transmit/receive element 601 (for example an antenna), a transceiver 603, physical (PHY) circuitry 605, and media access control (MAC) circuitry 607. PHY circuitry 605 and MAC circuitry 607 may be mmWave compliant layers and may also be compliant with one or more other IEEE 802.11ax or IEEE 802.13 standards. MAC circuitry 607 may be arranged to configure packets such as a physical layer convergence procedure (PLCP) protocol data unit (PPDUs) and arranged to transmit and receive PPDUs, among other things. MS device 600 may also include circuitry 609 configured to perform the various operations described herein. The circuitry 609 may be coupled to the transceiver 603, which may be coupled to the transmit/receive element 601. While FIG. 1A depicts the circuitry 609 and the transceiver 603 as separate components, the circuitry 609 and the transceiver 603 may be integrated together in an electronic package or chip.

In some embodiments, the MAC circuitry 607 may be arranged to contend for a wireless medium during a contention period to receive control of the medium for an appropriate control period and configure a High Efficiency WLAN (HEW) Physical Layer Convergence Protocol (PLCP) Protocol Data Unit (HEW PPDU). In some embodiments the PHY circuitry 605 may be arranged to transmit 5G mmWave packets. In some embodiments, the MAC circuitry 607 may be arranged to contend for the wireless medium based on channel contention settings, a transmitting power level, and a Clear Channel Assessment (CCA) level.

In some embodiments the PHY circuitry 605 may be arranged to transmit the HEW PPDU. The PHY circuitry 605 may include circuitry for modulation/demodulation, upconversion/downconversion, filtering, amplification, and the like. In some embodiments, the circuitry 609 may include one or more processors which may be configured for parallel processing. The circuitry 609 may be configured to perform functions based on instructions being stored in a RAM or ROM, or based on special purpose circuitry. The circuitry 609 may include processing circuitry and/or transceiver circuitry in some embodiments. The circuitry 609 may include a processor such as a general purpose processor or special purpose processor. The circuitry 609 may implement one or more functions associated with transmit/receive elements 601, the transceiver 603, the PHY circuitry 605, the MAC circuitry 607, and/or the memory 611. In some embodiments, the circuitry 609 may be configured to perform one or more of the functions and/or methods described herein.

In some embodiments, the transmit/receive elements 601 may be two or more antennas that may be coupled to the PHY circuitry 605 and arranged for sending and receiving signals including transmission of the HEW packets. The transceiver 603 may transmit and receive data such as HEW PPDU and packets that include an indication that the MS device 600 should adapt the channel contention settings according to settings included in the packet. The memory 611 may store information for configuring the other circuitry to perform operations for configuring and transmitting HEW packets and performing the various operations to perform one or more of the functions and/or methods described herein.

In some embodiments, the MS device 600 may be configured to communicate using OFDM communication signals over a multicarrier communication channel. In some embodiments, MS device 600 may be configured to communicate in some one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1A, although the scope of the embodiments is not limited in this respect as they may also be suitable to transmit and/or receive communications in some other techniques and standards. In some embodiments, the MS device 600 may use 4× symbol duration of 802.11n or 802.11ac.

In some embodiments, an MS device 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, and the like), an access point, a base station, a transmit/receive device for a wireless standard such as 802.11 or 802.16, or other device that may receive and/or transmit information wirelessly. In some embodiments, the MS device may include one or more of a keyboard, a display, a non-volatile memory port, multiple antennas, a graphics processor, an application processor, speakers, and other mobile device elements. The display may be an LCD screen including a touch screen.

The transmit/receive element 601 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas may be effectively separated to take advantage of spatial diversity and the different channel characteristics that may result.

Although the MS device 600 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be implemented fully or partially in software and/or firmware. This software and/or firmware may take the form of instructions contained in or on a non-transitory computer-readable storage medium, or a machine-readable hardware storage device. Those instructions may then be read and executed by one or more processors to enable performance of the operations described herein. Those instructions may then be read and executed by one or more processors to cause the MS device 600 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, and the like.

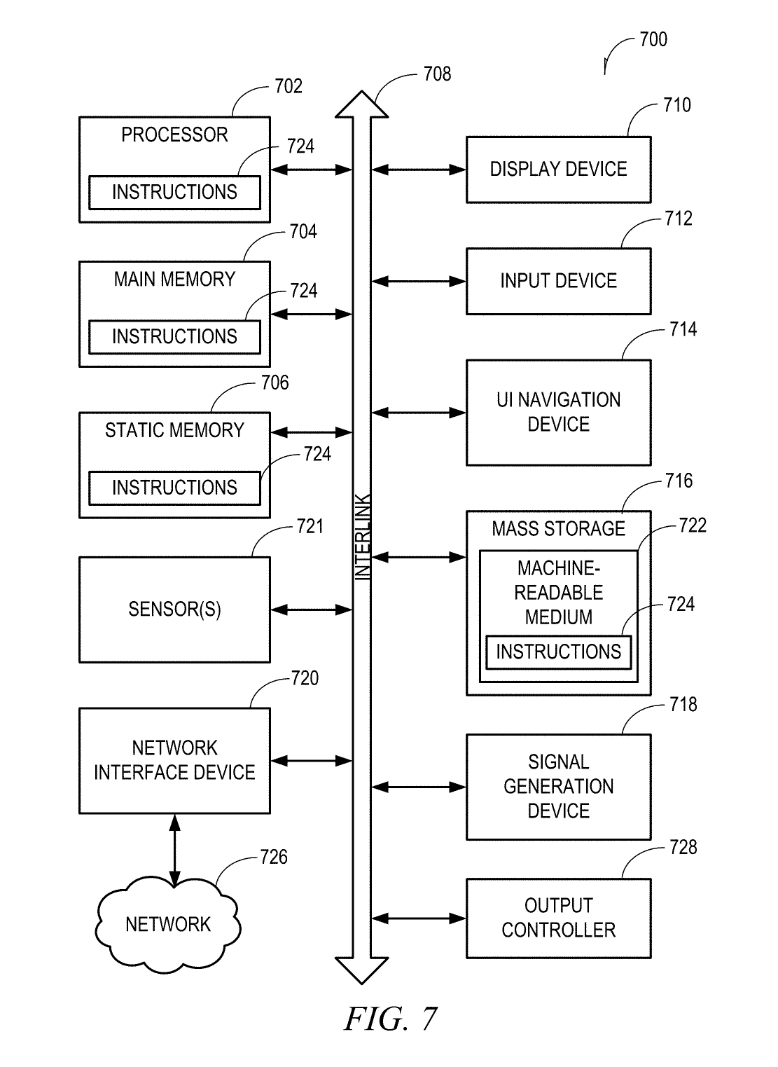

FIG. 7 illustrates a block diagram of an example machine in accordance with some aspects of the disclosure. The machine 700 is an example machine upon which any one or more of the techniques and/or methodologies discussed herein may be performed. In alternative aspects of the disclosure, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a mobile device, such as the mobile device 100 of FIG. 1A, which may be user equipment (UE). The machine 700 may also be a STA, an evolved Node B (eNB), a base station such as infrastructure equipment radio head 600, a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media. In some aspects of the disclosure, the machine readable medium may be or may include a non-transitory computer-readable storage medium.

While the machine readable medium 722 is illustrated as a single medium, the term “machine readable medium” may include a single medium or multiple media (e.g., a centralized or distributed database, and/or associated caches and servers) configured to store the one or more instructions 724. The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Ostitute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques. The term “transmission medium” shall be taken to include any intangible medium that is capable of storing, encoding or carrying instructions for execution by the machine 700, and includes digital or analog communications signals or other intangible medium to facilitate communication of such software.

Aspects of the disclosure may be implemented in one or a combination of hardware, firmware and software. Aspects of the disclosure may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some aspects of the disclosure may include one or more processors and may be configured with instructions stored on a computer-readable storage device.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

What is claimed is:

1. A security device comprising:
a socket comprising an extendible and collapsible accordion-like compartment, the socket configured to attach substantially flat to a mobile device or a mobile device case when the accordion-like compartment is collapsed, and configured to be gripped when the accordion-like compartment is extended while attached to the mobile device or mobile device case, the socket further configured to detach from the mobile device or mobile device case while the socket is gripped and the mobile device is pulled from the gripped socket by a second party, wherein the socket is further configured to remain gripped when the mobile device remains with the second party;
a transmitter within the accordion-like compartment; and
a switch coupled to the transmitter, the switch configured to activate and deactivate the transmitter, wherein
when activated, the transmitter transmits a radio frequency (RF) signal that comprises the identity of, and location associated with, the socket.

2. The security device of claim 1 wherein the identity of the socket includes the identity of a first party.

3. The security device of claim 1 further comprising location tracking circuitry, wherein the location tracking circuitry is coupled to the transmitter for transmitting the location associated with the socket.

4. The security device of claim 1 wherein the transmitter transmits an alarm to a dispatching agency.

5. The security device of claim 4 wherein the alarm comprises the RF signal that provides the identity of, and the location associated with, the socket.

6. The security device of claim 5 wherein the identity of the socket includes the identity of the mobile device or the identity of a first party.

7. The security device of claim 3 wherein the location tracking circuitry comprises global positioning system (GPS) tracking circuitry.

8. A security device comprising:
a socket comprising an extendible and collapsible accordion-like compartment, the socket configured to attach substantially flat to an article when the accordion-like compartment is collapsed, and configured to be gripped when the accordion-like compartment is extended, the socket configured to detach from the article while the socket is gripped and the article is pulled from the gripped socket by a second party, wherein the socket is further configured to remain gripped when the article remains with the second party;
a transmitter within the accordion-like compartment; and
a switch that is coupled to the transmitter, the switch configured to be activated to supply power to the transmitter and deactivated to remove power from the transmitter, wherein
when power is supplied to the transmitter the transmitter transmits an RF signal that comprises the identity of, and location associated with, the socket.

9. The security device of claim 8 further comprising a computer memory configured to store the identity of a first party.

10. The security device of claim 9 wherein the identity of the first party includes the identity of the socket.

11. The security device of claim 9 further comprising location tracking circuitry, wherein the location tracking circuitry is coupled to the transmitter for transmitting the location associated with the socket or with first party.

12. The security device of claim 9 further comprising location tracking circuitry, wherein the location tracking circuitry forms part of the transmitter.

13. The security device of claim 9 wherein the transmitter transmits an alarm to a dispatching agency.

14. The security device of claim 13 wherein the alarm comprises the identity of the socket or the identity of the first party.

15. The security device of claim 13 wherein the alarm comprises the location associated with the first party.

16. The security device of claim 11 wherein the location tracking circuitry comprises GPS tracking circuitry.

17. A security device comprising:
a socket comprising an extendible and collapsible accordion-like compartment, the socket configured to attach substantially flat to a vehicle when the accordion-like compartment is collapsed, and configured to be gripped when the accordion-like compartment is extended, the socket configured to be detached from the vehicle when the socket is gripped and the vehicle is being taken by a second party, wherein the socket is further configured to remain gripped when the vehicle remains with the second party;
a transmitter within the accordion-like compartment; and
a switch that is coupled to the transmitter, the switch configured to be activated by to supply power to the transmitter and deactivated to remove power from the transmitter, wherein
when power is supplied to the transmitter the transmitter transmits an RF signal that comprises the identity of, and location associated with, the socket.

18. The security device of claim 17 further comprising location tracking circuitry, wherein the location tracking circuitry is coupled to the transmitter for transmitting the location associated with the socket.

19. The security device of claim 17 further comprising location tracking circuitry, wherein location tracking circuitry forms part of the transmitter and the transmitter is further configured to transmit information comprising the location associated with a first party.

20. The security device of claim 17 wherein the transmitter transmits an alarm to a dispatching agency, and the alarm comprises the RF signal.

21. The security device of claim 20 wherein the RF signal comprises the identity of the socket or the identity of a first party.

22. The security device of claim 17 wherein the identity of the socket includes the identity of a first party.

23. The security device of claim 18 wherein the location tracking circuitry comprises GPS tracking circuitry.

24. A security device comprising:
a socket comprising an extendible and collapsible accordion-like compartment, the socket configured to attach substantially flat to an article when the accordion-like compartment is collapsed;
a transmitter within the accordion-like compartment; and
a switch that is coupled to the transmitter, the switch configured to be activated to supply power to the transmitter and deactivated to remove power from the transmitter, wherein
when power is supplied to the transmitter the transmitter transmits an RF signal that comprises the identity of, and location associated with, the socket.

25. The security device of claim 24 further comprising location tracking circuitry, wherein the location tracking circuitry is coupled to the transmitter for transmitting the location associated with the socket.

26. The security device of claim 25 further comprising location tracking circuitry, wherein location tracking circuitry forms part of the transmitter and the transmitter is configured to transmit information comprising the location associated with the socket
